(19) United States
(12) Patent Application Publication
(10) Pub. No.: US 2008/0133493 A1
(43) Pub. Date: Jun. 5, 2008

(54) METHOD FOR MAINTAINING DATABASE CLUSTERING WHEN REPLACING TABLES WITH INSERTS

(76) Inventor: Michael Bender, Rye Brook, NY (US)

Correspondence Address: DUKE W. YEE, YEE AND ASSOCIATES, P.C., P.O. BOX 802333, DALLAS, TX, 75380, US

(21) Appl. No.: 11/566,292

(22) Filed: Dec. 4, 2006

(51) Int. Cl. G06F 17/30

(52) U.S. Cl. 707/4; 707/E17.014

(57) ABSTRACT

A computer implemented method, computer program product, and system for an improved structured query language (SQL) insert process. After the improved insert process selects a set of data to be inserted into a database, the process accesses the destination system catalog and reads the clustered index key for the database. The process then sorts the target data according to the clustered index key and inserts the target data into the destination database.

### BACKGROUND OF THE INVENTION

1. Field of the Invention

The present invention relates generally to an improved data processing system, and in particular, to a computer implemented method, data processing system, and computer program product for an improved functionality of a structured query language (SQL) insert process by providing a clustered index optimization of the data prior to insertion in a database.

2. Description of the Related Art

Data warehousing typically involves intensive querying and reporting processes across multiple tables in multiple databases. The term data warehousing generally refers to the combination of many different databases across an entire enterprise. A database is a set of data with a regular structure. The data in a database is comprised of the application data (data records) and the system catalog (metadata).

Database tools use structured query language (SQL) to move data from one table to another. SQL is currently the most popular computer language to create, modify, retrieve, and manipulate data from database systems. SQL is an American National Standard Institute (ANSI) and International Standardization Organization (ISO) standard.

Databases may take advantage of indexing to increase the speed of SQL process queries. The most common kind of index is a sorted list of the contents of a particular table column, with pointers to the row associated with the value. This table column is called a key. An index allows a set of table rows matching some criterion to be located quickly. Various methods of indexing commonly include B-trees, hashes, and linked lists.

There are two kinds of architectures for indexes, clustered and non-clustered. Clustered indexes are indexes that are built based on the same key by which the data is ordered on disk. Non-clustered indexes are indexes that are built on any key. Clustered indexes usually store the actual records within the data structure and, as a result, can be much faster than non-clustered indexes.

During the performance of many data modification operations on tables with clustered indexes, the well ordered physical relationship the clustered index has to the physical order of the data on the disk is disturbed. Thus, in performing common functions on the database, such as implementing an “INSERT into xxxx(select* from yyyy)” statement, table fragmentation occurs, leading to inefficiencies in future data queries.

### SUMMARY OF THE INVENTION

The illustrative embodiments provide a computer implemented method, computer program product, and system for an improved structured query language (SQL) insert process. After the improved insert process selects a set of data to be inserted into a database, the process accesses the destination database system catalog and reads the clustered index key for the database. The process then sorts the target data according to the clustered index key and inserts the target data into the destination database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system is shown in which illustrative embodiments may be implemented;

FIG. 3 is a block diagram of a known database system in which illustrative embodiments may be implemented;

FIG. 4 is a block diagram of a database table organized by clustered index in which illustrative embodiments may be implemented;

FIG. 5 illustrates the effects of inserting unsorted data into the known database table organized by clustered index;

FIG. 6 illustrates the effects of inserting data presorted by the clustered index key before insertion into the database table in accordance with the illustrative embodiments; and

FIG. 7 displays a top level flow chart of the steps for implementing an improved insert process in accordance with the illustrative embodiments.

### DETAILED DESCRIPTION OF THE PREFERRED EMBODIMENT

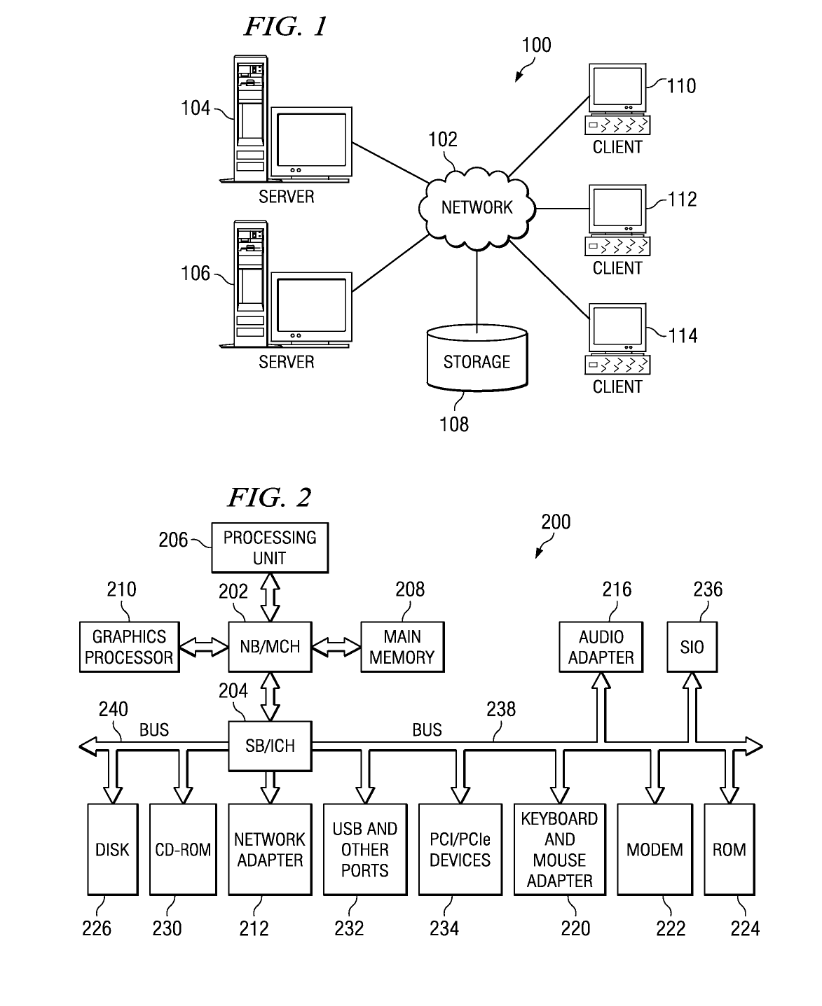

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

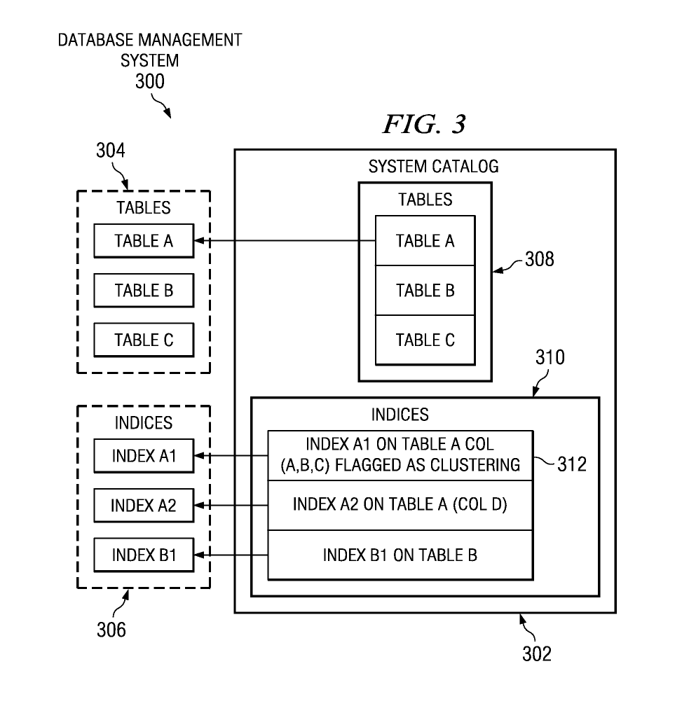

FIG. 3 is a block diagram of a known database management system in which illustrative embodiments may be implemented. Database management system 300 may reside in data processing system 200 as in FIG. 2. Database management system 300 comprises system catalog 302, tables 304, and indices 306. Those of ordinary skill in the art will appreciate that other components may be a part of database management system 300 and may be configured differently in accordance with the illustrative embodiments. System catalog 302 contains pointers to tables 308 and pointers to indices 310 along with a description of the indices. System catalog 302 identifies clustered index “Al” 312. The system catalog provides the key to the system indexes and data organization.

When building a clustered index, the SQL process parcels the data across pages and extents. An extent is the minimum amount of data that may be accessed. Each page within the extent links to another page with a pointer. This is called a page chain. The next page in the chain, however, may not be in the same extent. Therefore, as pages are read, another extent may be accessed, which may or may not involve additional input/output (I/O).

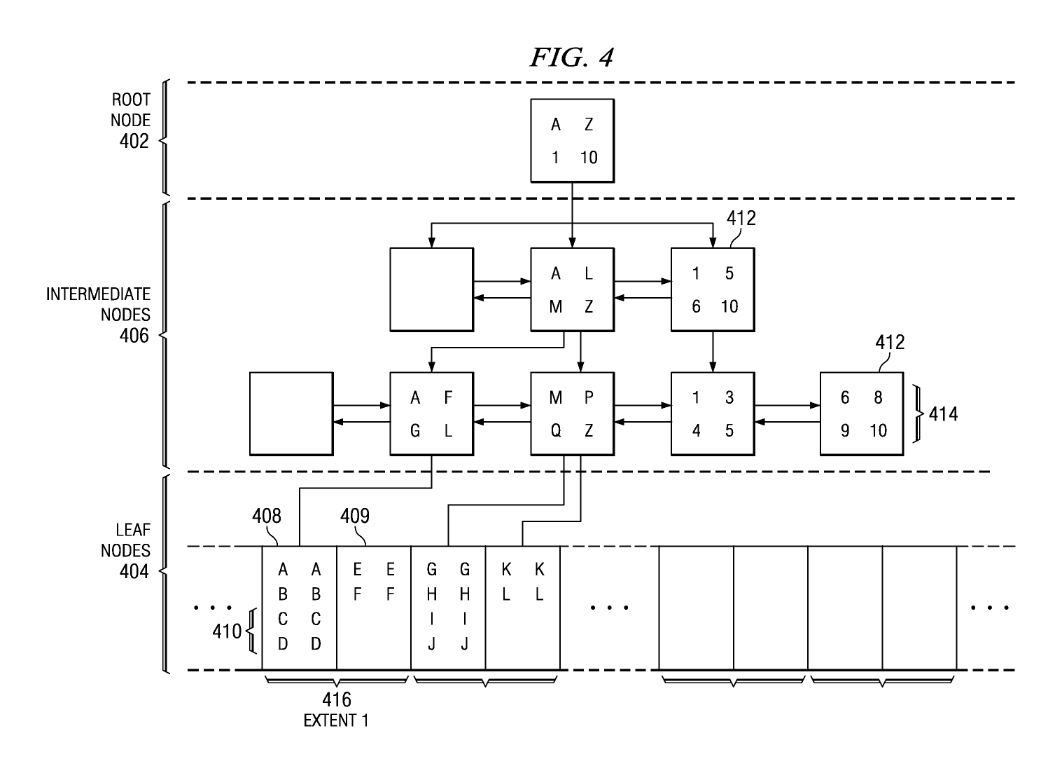

FIG. 4 is a block diagram of a known database table organized by clustered index in accordance with the illustrative embodiments. Clustered indexes are well known in the art and therefore will not be described in detail. Clustered indexes are organized as B-trees. Each page in an index B-tree is called an index node. The top node of the B-tree is called the root node, such as root node 402. The bottom level of nodes in the clustered index are leaf nodes, such as leaf nodes 404. Leaf nodes 404 of the clustered index are the physical location of the data depicted here in a page chain. Any index levels between the root and the leaf nodes are intermediate levels, such as intermediate level nodes 406. In a clustered index, leaf nodes 404 contain data pages, such as data page 408, which contain data rows, such as data rows 410 of the underlying table.

Root node 402 and intermediate level nodes 406 contain index pages 412 and holding index rows 414. Root node 402 points to the top of the clustered index in intermediate nodes 406 for a specific data partition. Index rows 414 contain a key value and a pointer to either an intermediate level page in the B-tree, or a data row in the leaf node of the index. The data processing system may have a minimum amount of data that may be accessed. The minimum amount is referred to herein as an extent.

Data page 408 in leaf nodes 404, and rows 410 in data page 408 are initially ordered on the value of the clustered index key. During a query, the SQL process moves through the index to find the starting key value in the range and then scans through the data pages using the previous or next pointers. Organizing data with a clustered index key enhances the performance of database queries. In a query of the database requesting all records beginning with C and D, the process follows the indexes down to leaf nodes 404. Extent 1 416 contains data pages 408 and 409, therefore data pages 408 and 409 will be read. An extent is the minimum amount of data that may be accessed by the data processor. For simplicity, in this example, two pages will be the number of pages in an extent. Therefore, even though data page 408 contains all of the data needed, data pages 408 and 409 will be accessed to retrieve the data requested. Therefore, in this example, two pages in one extent are read.

However, as the database is updated, the physical order of the data is disturbed by inserts and deletes to the database. Inserts are made at the point where the key value in the inserted row fits in the ordering sequence among existing rows. The SQL process allocates space for each row based on the space available at that time. As a result, while a clustered index stores the data rows in physical order on a page, the page may not be in physical order. Instead, each page has a link to the next page in the sequence. The allocations of pages for a table can be fragmented across sectors as the data is updated over time.

When an update to a row causes it to grow beyond the original space allocated for it, the row is split and the initial row location contains a pointer to another page where the entire row is stored. Inserting new columns into a table, for example, can lead to severe row splitting. As more rows are stored on separate pages, more time is required to access the additional pages. Row splitting may create further overhead for the SQL process with additional page reads, leading to high central processing unit (CPU) activity and unresponsiveness.

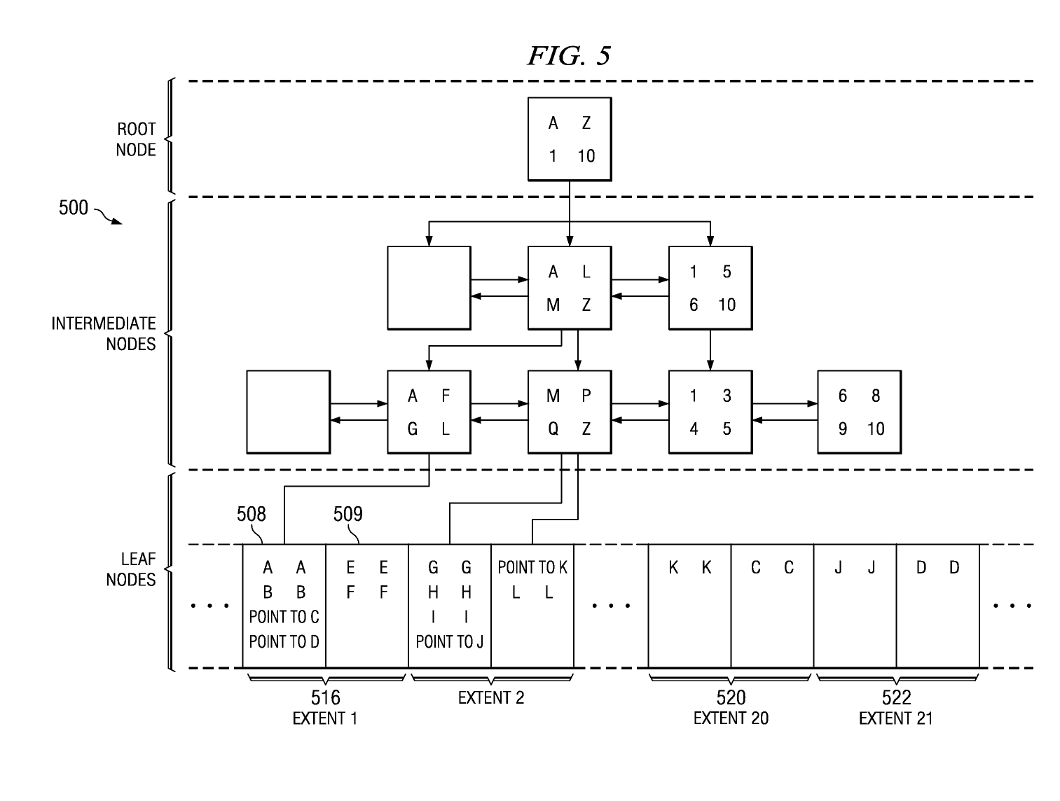

The inefficiencies are exacerbated if, upon inserting the new data set, the data set is in a random order with respect to the clustered index key. Consider the case of a database such as the database shown in FIG. 5. The effect of inserting unsorted data into the known database table organized by clustered index is illustrated. New data pages containing the rows K, C, J, and D have been inserted into the database. Therefore, when a query is performed requesting all records beginning with C and D, the index points to page 508 in extent 1 516, which in turn points to both extent 20 520 and extent 21 522. In the example of database 500, where the inserted set of data is unsorted with respect to the clustered index key, six pages must be read.

In attempts to optimize the database, the process of moving the data is frequently a two-step process. The first step is to delete the data using the “DELETE from xxxx” statement. The second step is to insert data into a table using the “INSERT into xxxx(select*from yyyy)” statement.

Database management systems may not allow the SELECT statement to sort the data, therefore data is inserted as in database 500 in FIG. 5, and the clustered index may no longer be optimal. Therefore, downstream users of the database experience poor performance.

The illustrative embodiments provide for a supplementation of the existing functionality of an INSERT statement in an SQL process by adding a parameter OPTIMZE FOR CLUSTERING to the INSERT statement. This improvement to the database management system reads the system catalog to read the clustered index that is defined for the target table, and then sorts the data in the SELECT part of the code according to the clustered index key before inserting the data into the table.

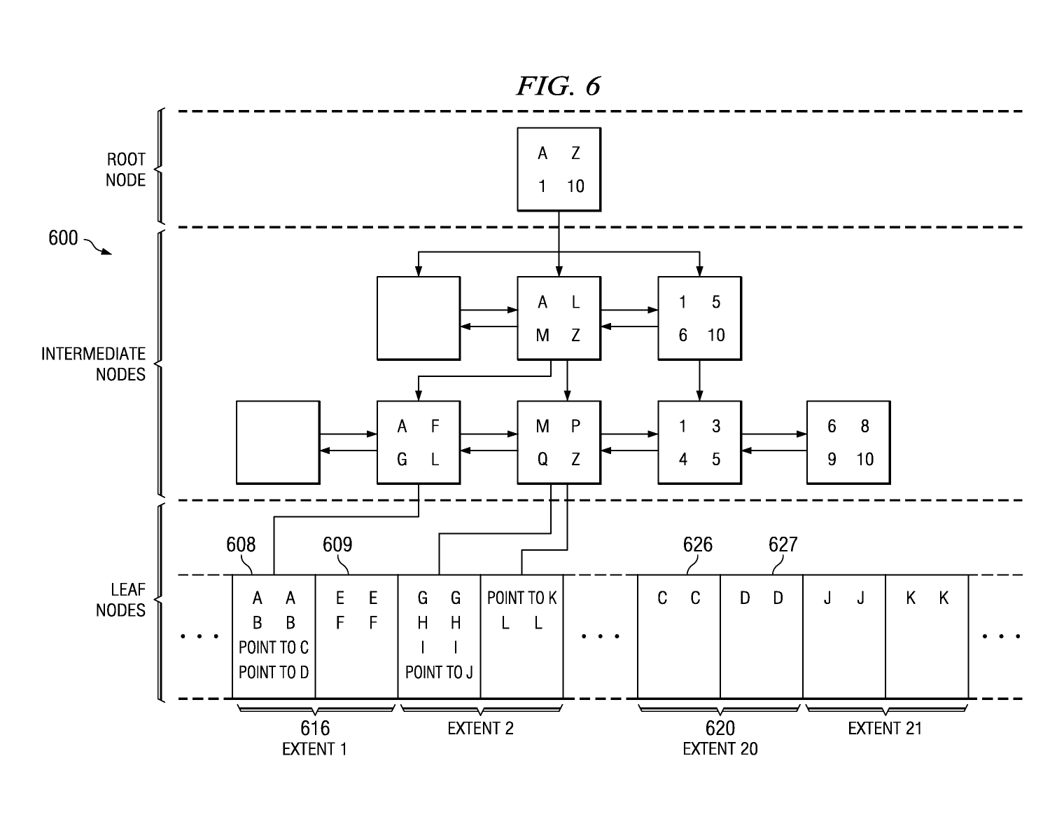

FIG. 6 illustrates a database that has been updated with inserts that have been presorted by the clustered index key before insertion into the database, according to the illustrative embodiments. Similar to database 500 in FIG. 5, database 600 has a clustered index organization with a data set inserted into the database. However, the set of data inserted into database 600 was presorted by the clustered index.

As in the examples above, the user queries the database for records beginning with C and D. The index points to page 608 and extent 1 616 is read. Pointers, in page 608, point to a page in extent 20 620. The two pages of extent 20 620 are read. As a result, during the query, the system accesses four pages of data, pages 608, 609, 626, and 627.

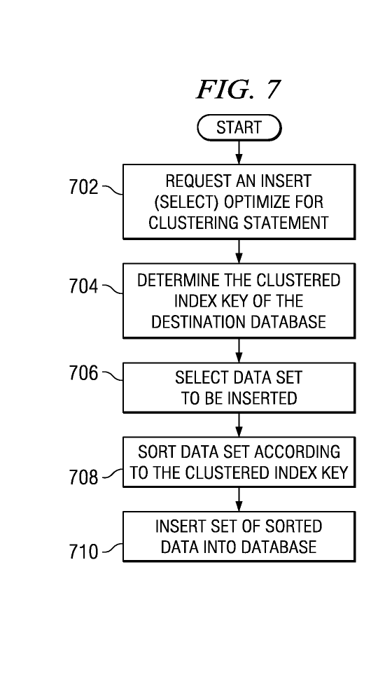

FIG. 7 displays a top level flow chart of the steps for implementing an improved insert process in accordance with the illustrative embodiments. The process begins when a user requests an INSERT(SELECT) OPTIMIZE FOR CLUSTERING statement (step 702). Those of ordinary skill in the art will appreciate that other words and syntax may be used to initiate the process according to the illustrative embodiments. The improved insert process accesses the database catalog, such as system catalog 302 of FIG. 3 to determine the clustered index key of the destination database (step 704). The data set to be inserted is selected (step 706). A data set is a set of data containing more than one datum. The data set is sorted according to the clustered index key (step 708). The set of sorted data is then inserted into the database (step 710).

The illustrative embodiments provide a computer implemented method, computer program product, and system for an improved SQL insert process. After the improved insert process selects a set of data to be inserted into a database, the process accesses the destination database system catalog and reads the clustered index key for the database. The process then sorts the target data according to the clustered index key and inserts the target data into the destination database.

An amplification of this solution may be realized if the database were then propagated, using a tool such as the IBM tool, Data Propagator™. Data Propagator would then issue the delete and insert statements in the correct order so any cloned copies of the tables would also be optimized for the clustered index. The database management system would then sort the sub-select data in memory, and then insert the rows into the target table. Since the data is sorted by the clustered index before the inserts, query performance against the table is significantly improved. When the database management system recognizes the OPTIMIZE FOR CLUSTERING parameter, it would read the system catalog and find the definitions for the cluster.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times, code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for a query language insert process, the computer implemented method comprising:
selecting a set of data to be inserted into a database;
accessing a clustered index in a system catalog associated with the database;
sorting the set of data to be inserted by the clustered index to form a sorted set of data; and
inserting the sorted set of data into the database.

2. The computer implemented method of claim 1, wherein the query language is a structured query language.

3. The computer implemented method of claim 1, wherein selecting, accessing, sorting, and inserting are accomplished in a single query statement.

4. A computer program product comprising:
a computer usable medium including computer usable program code for a query language insert process, the computer program product including:
computer usable program code for selecting a set of data to be inserted into a database;
computer usable program code for accessing a clustered index in a system catalog associated with the database;
computer usable program code for sorting the set of data to be inserted by the clustered index to form a sorted set of data; and
computer usable program code for inserting the sorted set of data into the database.

5. The computer program product of claim 4, further comprising:
computer usable program code, wherein the query language is a structured query language.

6. A data processing system for a query language insert process, the data processing system comprising:
a bus system;
a communications system connected to the bus system;
a memory connected to the bus system, wherein the memory includes a set of instructions; and
a processing unit connected to the bus system, wherein the processing unit executes the set of instructions to select a set of data to be inserted into a database, access a clustered index in a system catalog associated with the database, sort the set of data to be inserted by the clustered index to form a sorted set of data, and insert the sorted set of data into the database.

7. The data processing system of claim 6, wherein the query language is a structured query language.

8. The data processing system of claim 6, wherein selecting, accessing, sorting, and inserting are accomplished in a single query statement.
